(19) United States
(12) Patent Application Publication
(10) Pub. No.: US 2015/0193011 A1
(43) Pub. Date: Jul. 9, 2015

(54) Determining Input Associated With One-to-Many Key Mappings

(71) Applicant: Microsoft Corporation, Redmond, WA (US)

(72) Inventors: Guobin Shen, Beijing (CN); Matthew Robert Scott, Beijing (CN); Jiawei Gu, Shanghai (CN); Weipeng Liu, Beijing (CN); Shipeng Li, U, CA (US)

(73) Assignee: Microsoft Corporation, Redmond, WA (US)

(21) Appl. No.: 14/150,403

(22) Filed: Jan. 8, 2014

(51) Int. Cl. G06F 3/02; G06F 3/041; G06F 3/01

(52) U.S. Cl. CPC G06F 3/0227; G06F 3/017; G06F 3/041

(57) ABSTRACT

In some examples, a physical keyboard is used with a computing device. For instance, the physical keyboard can be integrated with a bottom bezel area of a tablet computing device. Gesture sensors can also be integrated with the physical keyboard to provide functionality associated with thumb gestures. To illustrate, thumb gestures can be used for spacebar functionality, zooming in and out of an area on a display, or rotating an area on a display. In some instances, touch sensors can also be integrated with one or more keys of the physical keyboard to provide additional input to the computing device for determining keyboard input. In an implementation, touch sensors can be integrated on a top surface of a key or on one or more sides of a key.

### BACKGROUND

Keyboards are important and popular input mechanisms for providing input to a variety of computing devices. For example, keyboards are often used to provide input for word processor applications, spreadsheet applications, database applications, internet applications, etc. Keyboards with mechanically movable keys (referred to herein as “physical keyboards”) generally provide some form of naturally occurring haptic feedback for a user who actuates a key. For example, one popular mechanism used for providing haptic feedback in physical keyboards is a “buckling spring” mechanism underneath each key that buckles when the user actuates a key. The buckling of the spring causes a snapping action that provides a tactile sensation to the user to indicate that the key has been actuated.

As computing devices have become smaller and more portable with advances in computer technology, the traditional mechanical keyboard has become less common, especially for computing devices with relatively small form factors. This is because the size of traditional physical keyboards is too large to be used or integrated with many portable electronic devices, such as tablet computing devices. Therefore, some computing devices use a thinner and more portable keyboard that retains the layout of a traditional physical keyboard. However, due to the thinner design of such keyboards, the haptic feedback associated with traditional physical keyboards is no longer present.

Furthermore, tablet computing devices typically do not have an integrated physical keyboard, but some tablet computing devices may have keyboard functionality associated with a touch-screen. For example, keys can be displayed on the touch-screen in a layout similar to a traditional mechanical keyboard. However, touch-screen keyboards do not typically provide haptic feedback that is associated with such physical keyboards.

### SUMMARY

Implementations described herein provide for a physical keyboard that is used with a computing device. For instance, the physical keyboard can be integrated with a bottom bezel area of a tablet computing device. In a particular implementation, gesture sensors can also be integrated with the physical keyboard to provide functionality associated with thumb gestures. For example, thumb gestures can be used for spacebar functionality, zooming in and out of an area on a display, or rotating an area on a display. In some instances, touch sensors can also be integrated with one or more keys of the physical keyboard to provide additional input to the computing device for determining keyboard input. To illustrate, touch sensors can be integrated on a top of a key or on one or more sides of a key.

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example computing device having a one-line keyboard according to some implementations.

FIG. 2 is a block diagram illustrating a representative computing device according to some implementations.

FIG. 3 illustrates an example of side touch sensors of a key of a physical keyboard according to some implementations.

FIG. 4A illustrates a top view of example touch sensors on a top surface of a key of a physical keyboard according to some implementations.

FIG. 4B illustrates a side view of the example key of FIG. 4A according to some implementations.

FIG. 5 illustrates a top view of example gesture sensors integrated with a physical keyboard according to some implementations.

FIG. 6 illustrates a side view of example gesture sensors integrated with a physical keyboard according to some implementations.

FIG. 7 is a flow diagram of an example method of determining keyboard input for a physical keyboard according to some implementations.

FIG. 8 is a flow diagram of another example method of determining keyboard input for a physical keyboard according to some implementations.

### DETAILED DESCRIPTION

The technologies described herein are generally directed toward a physical keyboard and determining input associated with one-to-many key mappings. As used herein, a physical keyboard can be any type of physical keyboard that includes a single row or single series of two or more keys. In some examples, the physical keyboard has a one-to-many mapping for one or more keys. For example, functionality associated with the 4 or 5 rows of a typical full-sized keyboard can be collapsed into one row of keys, such that each key has a one-to-many mapping. In particular, a key of the physical keyboard can be actuated to indicate an input of one alphanumeric character and/or another symbol of a number of alphanumeric characters and/or symbols associated with the key. To illustrate, actuation of a key of the physical keyboard can indicate an input of “Q”, “A”, “Z”, “1” or “!”.

The physical keyboard can be integrated with a computing device or attached to a computing device. For example, a physical keyboard can include a row of keys located below a display of a computing device, such as along a bottom of a tablet computing device. In some examples, the physical keyboard can be a peripheral device for use with a computing device as either an attached peripheral or a physically separate peripheral. Furthermore, in some examples, the physical keyboard is capable of communicating with the computing device via wires, wirelessly, or both.

As used herein, a “physical” keyboard has mechanically moveable keys that provide some form of naturally occurring haptic feedback for a user who presses the keys, as in many traditional keyboards that are used with desktop computers and laptop computers. As used herein, “pressing” a key occurs when a key is pushed down by a distance sufficient to actuate the key, which causes a key press input. For example, one popular mechanism used for providing haptic feedback in physical keyboards is a “buckling spring” mechanism underneath each key that buckles when the user presses a key. The buckling of the spring causes a snapping action that provides a tactile sensation to the user to indicate that the key has been actuated. However, other forms of haptic feedback may occur in response to a user pressing a key of a physical keyboard.

In some implementations, one or more sensors are integrated with one or more keys of the physical keyboard in order to detect touch and to provide a touch input signal. For example, one or more touch sensors can be affixed to the top surface of a key or located within or near the surface of the key. In some examples, an upper key sensor is integrated with the upper portion of the top surface, a middle key sensor is integrated with the middle portion of the top surface, and a lower key sensor is integrated with a lower portion of the top surface. In an implementation, a keyboard signal module can process key press input and input from one or more of the above sensors in order to determine a keyboard input. For example, for a key with a one-to-many mapping, a keyboard signal module may determine an “R” character as the keyboard input when a user presses a key and touches the upper key sensor of the upper portion of the top surface and a “V” character as the keyboard input when the user presses the key and touches the lower key sensor of the lower portion of the top surface.

In various implementations, one or more touch sensors can be affixed or integrated with one or more sides of a key. For example, a touch sensor can be integrated with a left side of a key, a right side of a key, a top side of a key, or a bottom side of a key. The keyboard signal module can process input from one or more of the above sensors in order to determine or generate a keyboard input. To illustrate, a keyboard signal module can process input from a touch sensor of a left side of a key in order to determine an escape character (ESC) as the keyboard input. Thus, a user can provide a touch input by touching a side of a key without pressing the key down for physical actuation. As used herein, a key press input is caused by pressing a key down to cause physical actuation of the key (as in a traditional physical keyboard), a touch input is caused by touching a touch sensor, and a keyboard input is determined or generated in response to the key press input, the touch sensor input, or both. For example, the keyboard input is generated before it is sent to a software application for processing. In other examples, a software application or a software component associated with an operating system generates the keyboard input. In still other examples, hardware or a combination of hardware and software generate the keyboard input. Furthermore, in some instances, a context is additionally taken into account to determine a keyboard input.

In some examples, a keyboard input is determined based on a key press input and a context associated with the keyboard input. To illustrate, the context can be one or more previously entered letters, numbers, symbols, words, sentences, or one or more previously determined keyboard inputs. As an example, if a first keyboard input is “d,” and a second keyboard input is “o,” and a user presses a key associated with the letters “t,” “g,” and “b,” a keyboard input of “g” can be determined based on the determination that the first and second inputs, when combined with the letter “g,” form a word (“dog”). Other examples of context associated with the keyboard input include the time of day, user preferences, and previous activity associated with the user, such as work activities, leisure activities, meetings attended, and web sites visited.

In an implementation, one or more gesture sensors can be affixed or integrated with the physical keyboard in order to detect thumb gestures, finger gestures, hand gestures, or other gestures made with any other body part. For example, certain thumb gestures can be used to provide space bar input. Thumb gestures can also be used to provide functionality such as zooming in or out of an area presented on a display or rotating an area presented on the display.

By collapsing functionality typically associated with keyboards into a physical keyboard, portability of the keyboard can be improved, while retaining the haptic feedback associated with physical keyboards. For example, a physical keyboard can be integrated into a bezel area of touch-screen devices, in order to provide a typing experience associated with other physical keyboards. Therefore, a physical keyboard can be well-suited for space constrained applications, such as tablet computing devices and other portable electronic devices, such as smart phones, portable gaming devices, portable media devices, and the like.

### Example Computing Device Using a Physical Keyboard

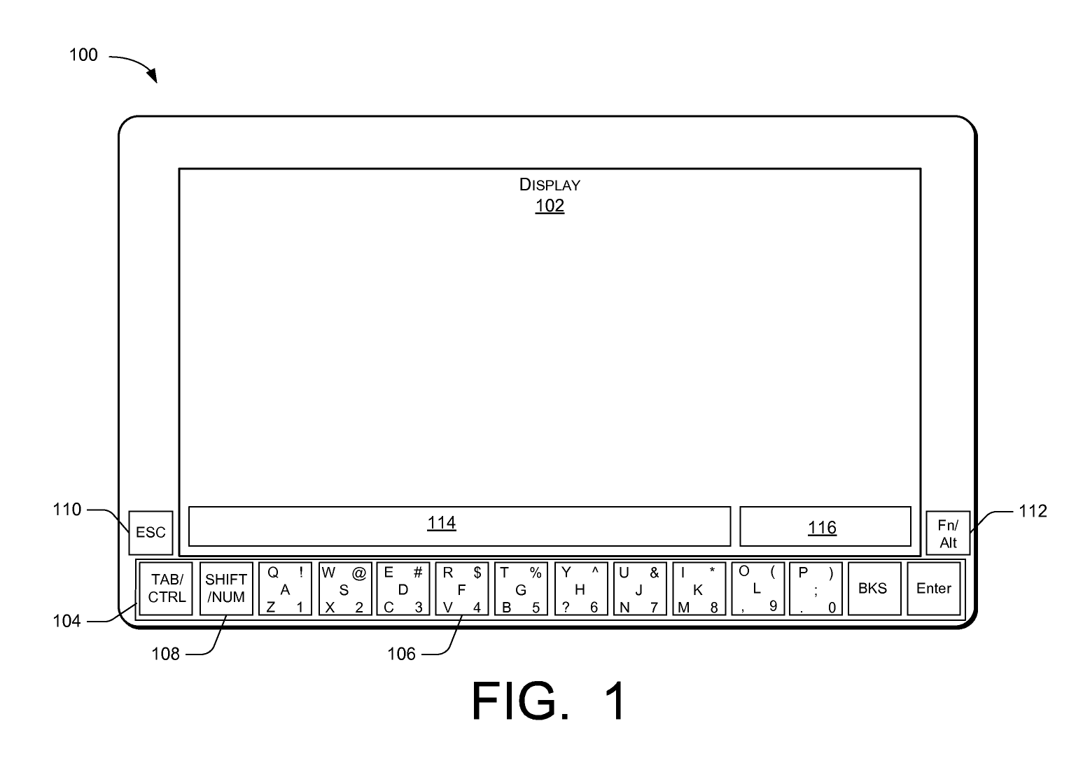

FIG. 1 illustrates an example computing device 100 according to some implementations. In the example, the computing device 100 includes a display 102 and a physical keyboard 104. The physical keyboard 104 has a single row of keys. In the illustrated example, the physical keyboard 104 is located beneath the display 102 in a bottom bezel area of the computing device 100. However, any other suitable location on the computing device 100 can be used.

In the example, a key of the physical keyboard 104 can be used for multiple functionalities that correspond to multiple keys of typical or traditional keyboards. Thus, keys of the physical keyboard 104 can be associated with a one-to-many mapping. For example, a key 106 can be used to enter “R,” (upper or lower case), “$,” “F,” (upper or lower case), “V,” (upper or lower case), or “4.” In some examples, a shift key 108 can be used in conjunction with the key 106 to enter “$” or “4.” Thus, one or more keys of the physical keyboard 104 can map any of the one or more keys of full-sized keyboards (e.g., alpha-numeric keys, punctuation keys shift keys, tab keys, control keys, escape keys, function keys, alt keys, backspace keys, enter keys, etc.).

In some implementations, one or more keys can be placed on other areas of the computing device 100 to provide input. In the example, an escape key 110 and a function key 112 are placed on a left and right side of the display 102, respectively. Thus, one or more additional keys can be placed on other areas of the computing device 100. Furthermore, one or more of the keys can be used in combination or in conjunction with one or more keys of the physical keyboard 104. For example, pressing the function key 112 concurrently with the key 106 may provide a different input character or input signal than only pressing the key 106.

In some examples, portions of the display 102 may provide information or functionality for the physical keyboard 104. A candidate selection area 114 may provide multiple input options associated with the physical keyboard 104. For example, in response to pressing the key 106, the candidate selection area can display two or more input options associated with the key 106, such as “R,” “F,” and “V.” Furthermore, in some implementations, a keyboard status indicator 116 may provide information associated with the physical keyboard 104. For example, the keyboard status indicator 116 can display a toggle status for one or more keys, such as a caps lock status of “on” or “off”. In some implementations, the display 102 presents a graphical representation of a one-to-many mapping associated with each key of the physical keyboard 104, wherein the graphical representation displays two or more keyboard inputs associated with each key.

In some examples, a user can use one or more combinations of keys to toggle between various input states associated with the physical keyboard 104. In an implementation, pressing a combination of two or more keys may change an input state to, from, or between number inputs, letter inputs, or symbol inputs or enable/disable sensors associated with the physical keyboard 104. For example, pressing two keys at approximately the same time can change functionality of one or more keys from being used for inputting letters to being used for inputting numbers. In other implementations, pressing one key multiple times or holding a key pressed down for at least a threshold amount of time may cause the input state to change or enable/disable sensors associated with the physical keyboard 104. For example, pressing a particular key twice within a threshold amount of time can change functionality of one or more keys from being used for inputting symbols to being used for inputting letters. Furthermore, any of the above techniques can be used to enable/disable a virtual keyboard that can be presented on the display 102.

In the illustrated example, the layout of the physical keyboard 104 is based on a QWERTY-layout keyboard. In other implementations, the physical keyboard 104 can be based on other keyboard layouts. Furthermore, in some implementations, the layout and mapping of the physical keyboard 104 can be changed and customized according to a user's preferences.

In some implementations, some keys can be used for letter inputs, some keys can be used for number inputs, and some keys can be used for symbol inputs. However, any suitable combination of key assignments can be used. In some examples, key assignments change one or more times depending on a time of day. In other examples, key assignments are user-specific and user-customizable, so that the key assignments change in response to a change of users of the physical keyboard 104. Thus, in some instances, the one-to-many mapping of each of the keys is configurable based on a user-defined mapping.

Furthermore, in some examples, the configuration of the physical keyboard can be based on a line of keys in series, a curve of keys in series, two or more segments of a series of keys that connect to form one or more vertices (such as a “V” shape or part of a rectangle), a circular series of keys, or any other arrangement of a series of keys suitable for entering input. For example, a curve of keys in series or a circular series of keys can be used on watches or other electronic devices.

### Example Computing System

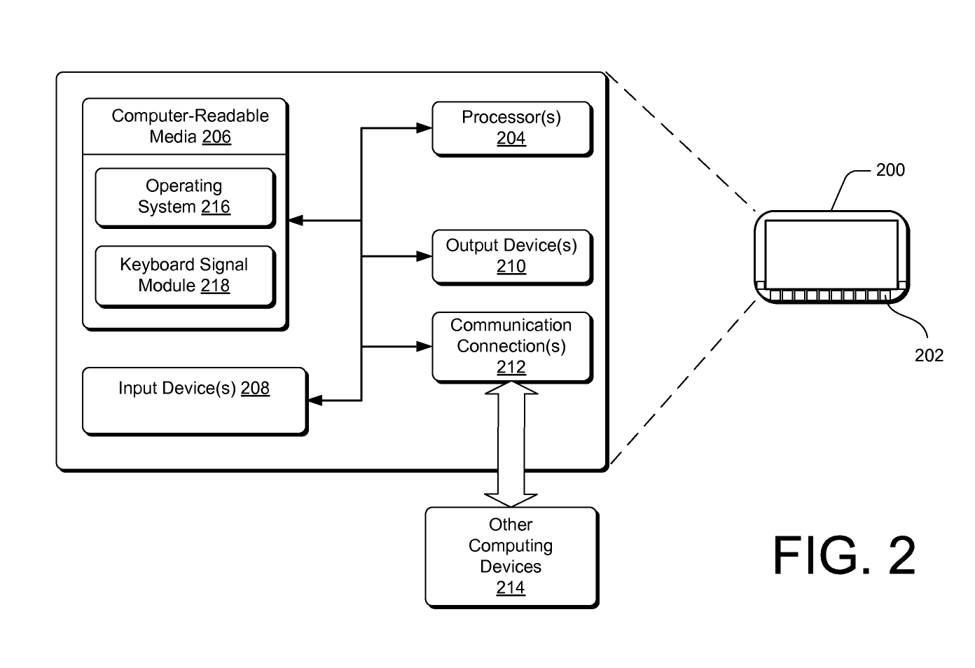

FIG. 2 is a block diagram illustrating a representative computing device 200 according to some implementations. The computing device 200 may include a physical keyboard 202. The physical keyboard 202 is an example implementation of the physical keyboard 104 of FIG. 1. In the illustrative example, the physical keyboard 202 is attached to or integrated with the computing device 200. Thus, the physical keyboard 202 can be physically connected to the computing device 200 through electrical couplings such as wires, pins, connectors, etc. In other examples, the physical keyboard 202 can be wirelessly connected to the computing device 200, such as via short-wave radio frequency (e.g., Bluetooth®), or another suitable wireless communication protocol. Thus, the computing device 200 shown in FIG. 2 is only one illustrative example of a computing device and is not intended to suggest any limitation as to the scope of use or functionality of the computing device. Neither should the computing device 200 be interpreted as having any dependency nor requirement relating to any one or combination of components illustrated in FIG. 2.

In at least one configuration, the computing device 200 comprises one or more processors 204 and computer-readable media 206. The computing device 200 may include one or more input devices 208, such as the physical keyboard 202. The input devices 208 may also include, in addition to the keyboard 202, a mouse, a pen, a voice input device, a touch input device, etc.

The computing device 200 may include one or more output devices 210 such as a display, speakers, printer, etc. coupled communicatively to the processor(s) 204 and the computer-readable media 206. The computing device 200 may also contain communications connection(s) 212 that allow the computing device 200 to communicate with other computing devices 214 such as via a network.

The computer-readable media 206 of the computing device 200 may store an operating system 216, and may include a keyboard signal module 218. The keyboard signal module 218 may include processing software that is configured to process signals received at the physical keyboard 202, such as signals generated from a key-press event, a gesture input, or a touch sensor on a side or top surface of a key. The keyboard signal module 218 can determine one or more keyboard inputs based on one or more of the signals from key-press events, gesture inputs, and touch sensors on a side or top surface of a key. For example, as described above, two or more sensors can be located on a top surface of a key for determining a keyboard input, based on the key being pressed and touch input on one or more of the sensors. Also, as described above, context can be used instead of or in addition to touch inputs for determining a keyboard input. Gesture inputs and touch sensors on a side of a key can also be used to determine a keyboard input. Moreover, any combination of one or more of gesture inputs, touch sensor inputs on a side of a key, touch sensor inputs on a top of a key, context, vocal input, and other key-press events can be used to determine a keyboard input.

In some instances, the physical keyboard 202 can include the keyboard signal module 218 or implement at least a portion of functionality of the keyboard signal module 218 is implemented by the physical keyboard 202. For example, if the keyboard signal module 218 is a peripheral device with respect to the computing device 200, then the keyboard signal module 218 can include the keyboard signal module 218 or implement at least a portion of functionality of the keyboard signal module 218.

In some implementations, the processor 204 is a microprocessing unit (MPU), a central processing unit (CPU), or other processing unit or component known in the art. Among other capabilities, the processor 204 can be configured to fetch and execute computer-readable processor-accessible instructions stored in the computer-readable media 206 or other computer-readable storage media. Communication connections 212 allow the device to communicate with other computing devices, such as over a network. These networks can include wired networks as well as wireless networks.

The one or more processors 204 may include a central processing unit (CPU), a graphics processing unit (GPU), a microprocessor, a digital signal processor, and so on. The computer-readable media 206 can be configured to store one or more software and/or firmware modules, which are executable on the one or more processors 204 to implement various functions. The term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.).

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. In some implementations, the functionality described herein can be performed, at least in part, by one or more hardware logic components of the physical keyboard 202. For example, a keyboard that is detachable, peripheral, or attached to the computing system 200 during assembly may perform, at least in part, the functionality described herein.

The computer-readable media 206 includes tangible and/or physical forms of media included in a device and/or hardware component that is part of a device or external to a device, including but not limited to random-access memory (RAM), static random-access memory (SRAM), dynamic random-access memory (DRAM), read-only memory (ROM), erasable programmable read-only memory (EPROM), electrically erasable programmable read-only memory (EEPROM), phase change memory (PRAM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

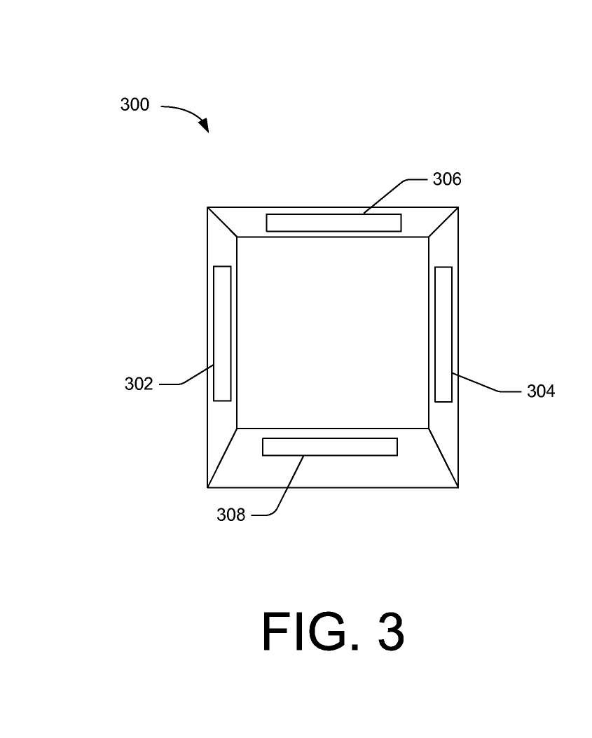

Although the computer-readable media 206 is depicted in FIG. 3 as a single unit, the computer-readable media 206 (and all other memory described herein) may include computer storage media or a combination of computer storage media and other computer-readable media. Computer-readable media 206 may include computer storage media and/or communication media. Computer storage media includes volatile and non-volatile, removable and non-removable media implemented in any method or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### Example of Side Touch Sensors

FIG. 3 illustrates an example of side touch sensors of a key 300 of a physical keyboard according to some implementations. In the illustrated example, the key 300 is an example of a key of the physical keyboard 104 of FIG. 1.

In the example, a left side touch sensor 302 can be integrated with a left side of the key 300, a right side touch sensor 304 can be integrated with the right side of the key 300, a top side touch sensor 306 can be integrated with the top side of the key 300, and a bottom side touch sensor 308 can be integrated with a bottom side of a key 300. In some examples, a keyboard signal module, such as the keyboard signal module 218 of FIG. 2, can process input from one or more of the above sensors in order to determine a keyboard input. For example, a keyboard signal module can process input from a touch sensor of a left side of a key in order to determine an escape character (ESC) as the keyboard input. Thus, a user can provide a keyboard input by touching a side of a key without pressing down on the key.

### Examples of Top Surface Touch Sensors

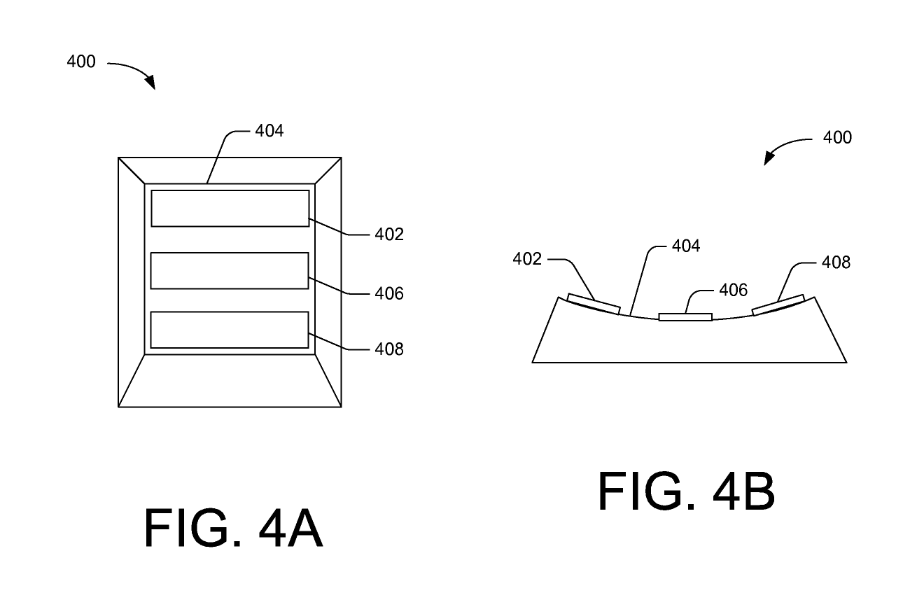

FIG. 4A illustrates an example of touch sensors on a top surface of a key 400 of a physical keyboard according to some implementations. In the illustrated example, the key 400 is an example of a key of the physical keyboard 104 of FIG. 1.

In the example, an upper key touch sensor 402 can be integrated with an upper portion of a top surface 404 of the key 400 for detecting touch. A middle key touch sensor 406 can also be integrated with a middle portion of the top surface 404 of the key 400 for detecting touch. A lower key touch sensor 408 can also be integrated with a lower portion of the top surface 404 of the key 400 for detecting touch. In some examples, a keyboard signal module, such as the keyboard signal module 218 of FIG. 2, can process input from one or more of the above sensors in conjunction with a key press input in order to determine a keyboard input. In an example, the key 400 is associated with the characters R, F, and V, such that when the upper key touch sensor 402 detects touch input, an “R” is determined as the keyboard input, when the middle key touch sensor 406 detects touch input, an “F” is determined as the keyboard input, and when the lower key touch sensor 408 detects touch input, a “V” is determined as the keyboard input. Thus, in some implementations, the keyboard input is selected based at least in part on a location on the key 400 of the touch sensor that detects the touch input or a location on the key 400 of the touch sensor that detects the touch input relative to the locations on the key 400 of one or more of the other touch sensors.

In some examples, a keyboard signal module will also process input from the middle key touch sensor 406 and the lower key touch sensor 408 in order to determine the keyboard input. For example, a keyboard signal module may determine the letter “F” or “V” as the keyboard input. Thus, a keyboard signal module can process one or more inputs from one or more sensors integrated on the top surface 404, along with the key press input, in order to determine a keyboard input.

Furthermore, in some instances, one or more touch sensors can be integrated along a left ridge, right ridge, top ridge, or bottom ridge of the top surface 404 in order to determine a user's input intention or assign a probability that the user intends to provide a particular keyboard input. For example, a sensor located at the top ridge can detect touch input, which can cause a keyboard signal module to determine that the user intends to enter the letter “R.”

FIG. 4B illustrates a side view of the example key 400 of FIG. 4A according to some implementations. In the example, the top surface 404 is curved, which can provide tactile feedback to a user regarding a location of the top surface 404 that the user is touching. For example, a user that wishes to enter the letter “R” may choose to press the key 106 on an upper portion of the top surface 404 by feeling the top portion of the curve.

In some examples, the keyboard signal module 218 can determine input based at least in part on one or more algorithms or processing steps. For example, the keyboard signal module 218 can determine a probability that a user intends to provide an input, such as “R,” based on input from one or more of the upper key touch sensor 402, the middle key touch sensor 406, the lower key touch sensor 408, and one or more algorithms or processing. For example, if input is only received from the upper key touch sensor 402, then a greater probability will can be assigned to the letter “R” than the letters “F” or “V.” Furthermore, a greater probability can be assigned to the letter “F” than the letter “V” because touch input is received by a sensor that is closer to the letter “F” then the letter “V.” Therefore, in some examples, the probability of determining a particular keyboard input (e.g., “V”) can be inversely proportional to the distance between the sensor associated with the particular keyboard input and the sensor that receives touch input (e.g., the upper key touch sensor 402).

In some instances, the keyboard signal module 218 can determine input based at least in part on word auto-correction algorithms, such as dictionary-based word correction and user-specific dictionary learning. Furthermore, in some examples, the keyboard signal module 218 can determine input based at least in part on context-based auto-correction algorithms that take into account previous work of a specific user. Therefore, the keyboard signal module 218 can determine a keyboard input based not only on key press inputs or touch sensor inputs, but also based on one or more algorithms for selecting a keyboard input out of several possible keyboard inputs.

### Examples of Gesture Sensors

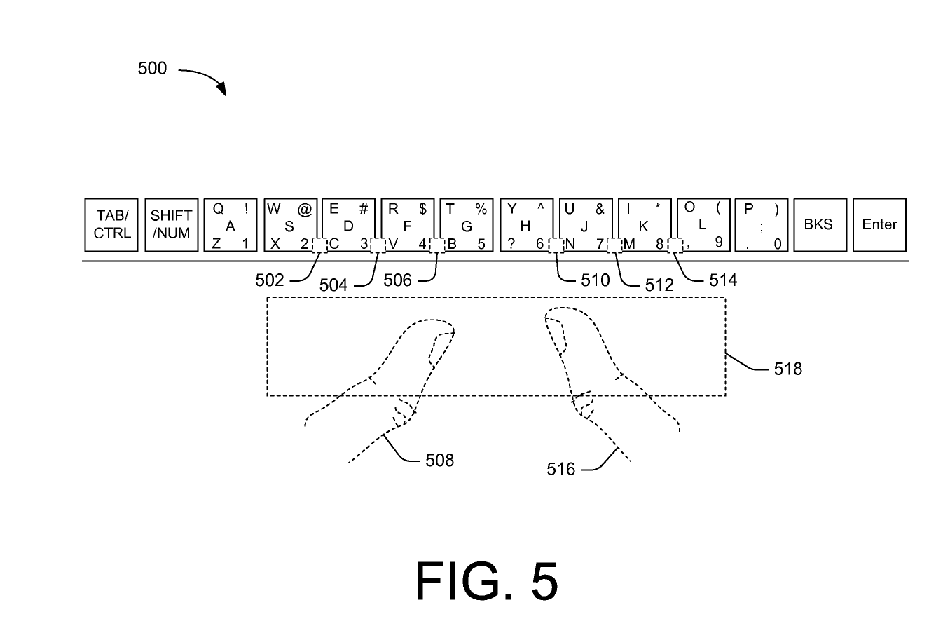

FIG. 5 illustrates an example of gesture sensors integrated with a physical keyboard 500 according to some implementations. The physical keyboard 500 can be an example of the physical keyboard 104 of FIG. 1. In the example, gesture sensors 502, 504, and 506 integrated with the physical keyboard 500 and configured to detect gestures of a left thumb 508 and gesture sensors 510, 512, and 514 integrated with the physical keyboard 500 are configured to detect gestures of a right thumb 516. However, any number of one or more gesture sensors suitable for detecting gestures of the left thumb 508 or right thumb 516 can be integrated with the physical keyboard 500. Furthermore, any other body parts suitable for performing gestures can be used, as described above. In some examples, the physical keyboard 104 provides audio feedback in response to detecting a gesture of the left thumb 508 or the right thumb 516. In an implementation, upon detecting a gesture of a user, an audio source produces a sound that indicates that the gesture was detected.

In the example, the gesture sensors 502, 504, 506, 510, 512, and 514 are located beneath and in between keys of the physical keyboard 500. However, any other location on or near the physical keyboard 500 suitable for detecting gestures of the left thumb 508 or right thumb 516 can be chosen for the gesture sensors 502, 504, 506, 510, 512, and 514. Furthermore, the gesture sensors 502, 504, 506, 510, 512, and 514 may use infrared technology or any other suitable technology for detecting gestures of the left thumb 508 or right thumb 516.

In the illustrated example, each of the gesture sensors 502, 504, and 506 are configured to provide a gesture input signal (e.g., to a keyboard signal module) in response to detecting a left thumb 508 gesture within a threshold distance of each respective gesture sensor. Likewise, each of the gesture sensors 510, 512, and 514 are configured to provide a gesture input signal (e.g., to a keyboard signal module) in response to detecting a right thumb 516 gesture within a threshold distance of each respective gesture sensor. In the illustrated example, the detection area 518 represents a range of distances in which one or more of the gesture sensors 502, 504, 506, 510, 512, and 514 are capable of detecting thumb gestures. Furthermore, in some examples, one or more of the gesture sensors 502, 504, 506, 510, 512, and 514 are capable of detecting gestures from fingers or any other body parts or objects suitable for creating gestures.

As an example, movement or flicking of the left thumb 508 towards the left may cause one or more of the gesture sensors 502, 504, and 506 to provide an input signal associated with pressing a left arrow key, thus providing left arrow functionality (e.g., moving a cursor left). Similarly, movement or flicking of the right thumb 516 towards the right may cause one or more of the gesture sensors 510, 512, and 514 to provide an input signal associated with pressing a right arrow key, thus providing right arrow functionality (e.g., moving a cursor right). In some examples, the speed with which the left thumb 508 or the right thumb 516 moves can be detected and scaled in order to drive cursor motion on a display. For example, the speed with which the cursor moves can be proportional to the speed at which the left thumb 508 or the right thumb 516 moves.

In some examples, movement of the left thumb 508 towards or away from one or more of the gesture sensors 502, 504, and 506 can cause the one or more of the gesture sensors 502, 504, and 506 to provide an input signal associated with other functionality, such as pressing a space bar or pressing a left side of a space bar. Similarly, movement of the right thumb 516 towards or away one or more of the gesture sensors 510, 512, and 514 may cause the one or more of the gesture sensors 510, 512, and 514 to provide an input signal associated with functionality, such as pressing the space bar or pressing a right side of a space bar.

In some examples, two or more of the gesture sensors 502, 504, 506, 510, 512, and 514 may concurrently detect movement of both the left thumb 508 and the right thumb 516 in order to provide other functions, such as selecting an area on a display, zooming in or out of an area on a display, or rotating an area left or right on a display (e.g., for image selection and manipulation). For example, moving the left thumb 508 and the right thumb 516 away from each other may increase a size of a selection area or cause zooming in of a selected area on a display. Conversely, moving the left thumb 508 and the right thumb 516 towards each other may decrease a size of a selection area or cause zooming out of a selected area on a display.

In some examples, a user may customize the functionality of the above thumb movements or any other thumb movements suitable for being detected by the gesture sensors 502, 504, 506, 510, 512, and 514 in order to provide functionality described above or any other functionality suitable for use with gesture input. In some implementations, a user may increase or decrease a size of the detection area 518. A user may also change a rate at which zooming in or zooming out occurs when implementing the zooming functionality described above. In other implementations, a user may associate one or more different operating system tasks or software application functions with one or more respective different gestures.

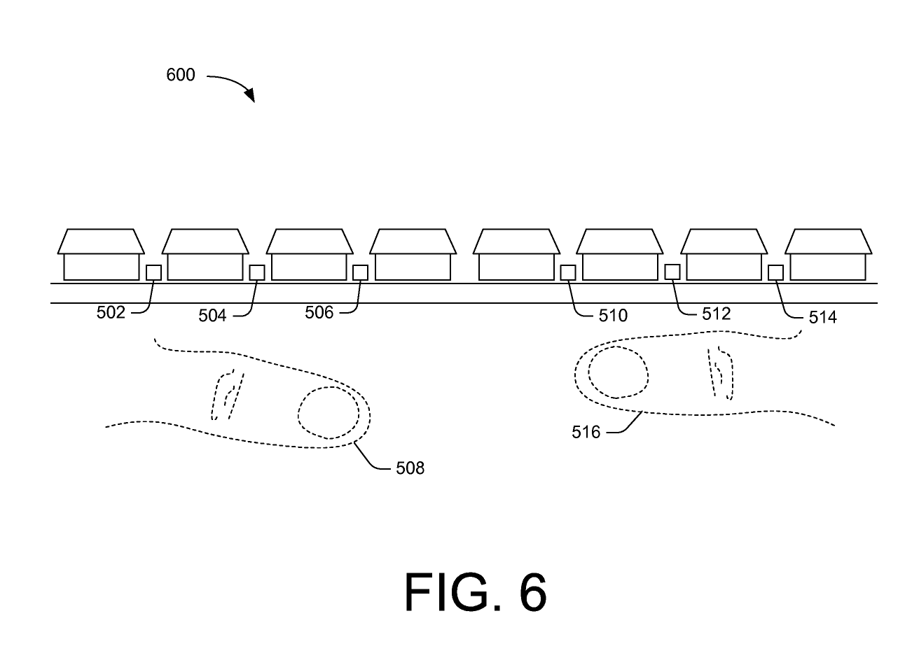

FIG. 6 illustrates an example of gesture sensors integrated with a physical keyboard 600 according to some implementations. The physical keyboard 600 is an example of the physical keyboard 500 of FIG. 5, viewed from the front instead of above as in FIG. 5.

In the example, movement or swiping of the left thumb 508 up or down may cause one or more of the gesture sensors 502, 504, and 506 to provide an input signal associated with the movement. Similarly, movement or swiping of the right thumb 516 up or down may cause one or more of the gesture sensors 510, 512, and 514 to provide an input signal associated with the movement. For example, moving the left thumb 508 down while moving the right thumb 516 up may cause counter-clockwise rotation of a selected area on a display, whereas moving the left thumb 508 up while moving the right thumb 516 down may cause clockwise rotation of a selected area on a display.

### Example Processes

In the following flow diagram, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. While several examples are described herein for explanation purposes, the disclosure is not limited to the specific examples, and can be extended to additional devices, environments, applications and settings. For discussion purposes, the processes below are described with reference to the environment 100 of FIG. 1, although other devices, systems, frameworks, and environments can implement this process.

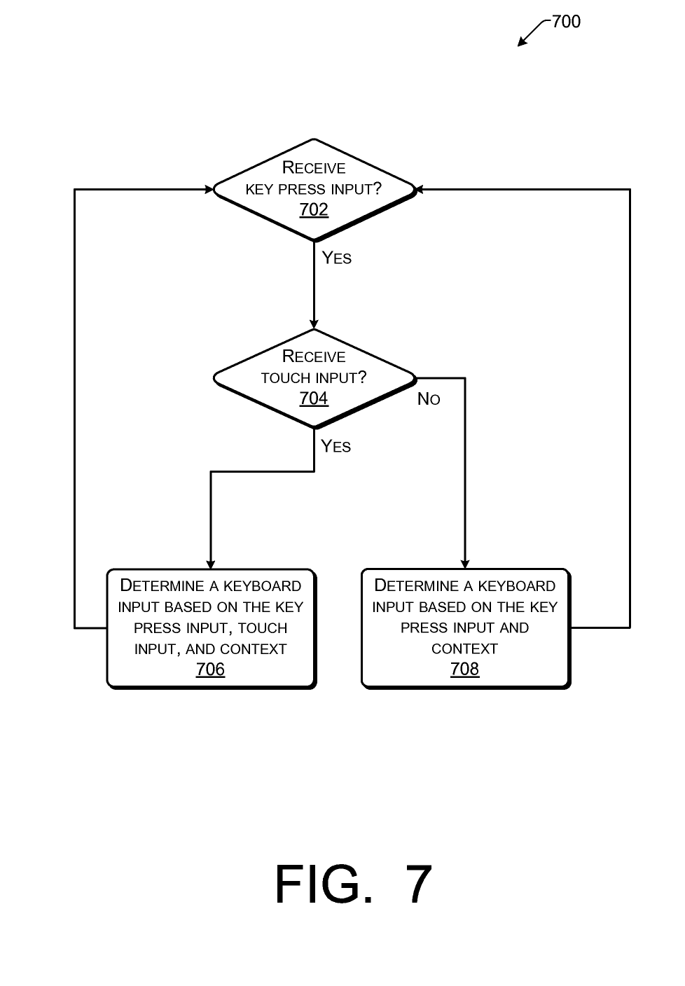

FIG. 7 is a flow diagram of an example method 700 of determining keyboard input for a physical keyboard according to some implementations. In the illustrative example of FIG. 7, the operations of the method 700 are performed by the keyboard signal module 218. In some implementations, one or more of the operations are performed by another component of the computing device 200, such as the operating system 216. In some examples, one or more of the operations are performed by the physical keyboard 104 (e.g., software, hardware, or a combination of hardware and software of the physical keyboard 104). Thus, logic in the physical keyboard 104 can perform one or more or each of the operations. For example, one or more of the modules and corresponding functionality of the computing device 200 can be incorporated into the physical keyboard 104.

At 702, if the keyboard signal module 218 determines that the physical keyboard 104 receives a key press input by one or more keys, then the method proceeds to 704. At 704, if the keyboard signal module 218 determines that the physical keyboard 104 also receives a touch input, then the method proceeds to 706. Otherwise, the method proceeds to 708. For example, the keyboard signal module can determine that a touch input is received concurrent with or within a threshold amount of time of a key press input. As an example, the keyboard signal module 218 may determine a keyboard input of the letter “R” based on the key 106 being pressed and receiving touch input by a particular touch sensor, such as the upper key touch sensor 402 of FIG. 4. At 706, the keyboard signal module 218 determines a keyboard input based on the key press input, the touch input, and context. In some examples, the determination is made without taking into account context. The method then returns to 702. At 708, the keyboard signal module 218 determines a keyboard input based on the key press input and context. The method then returns to 702.

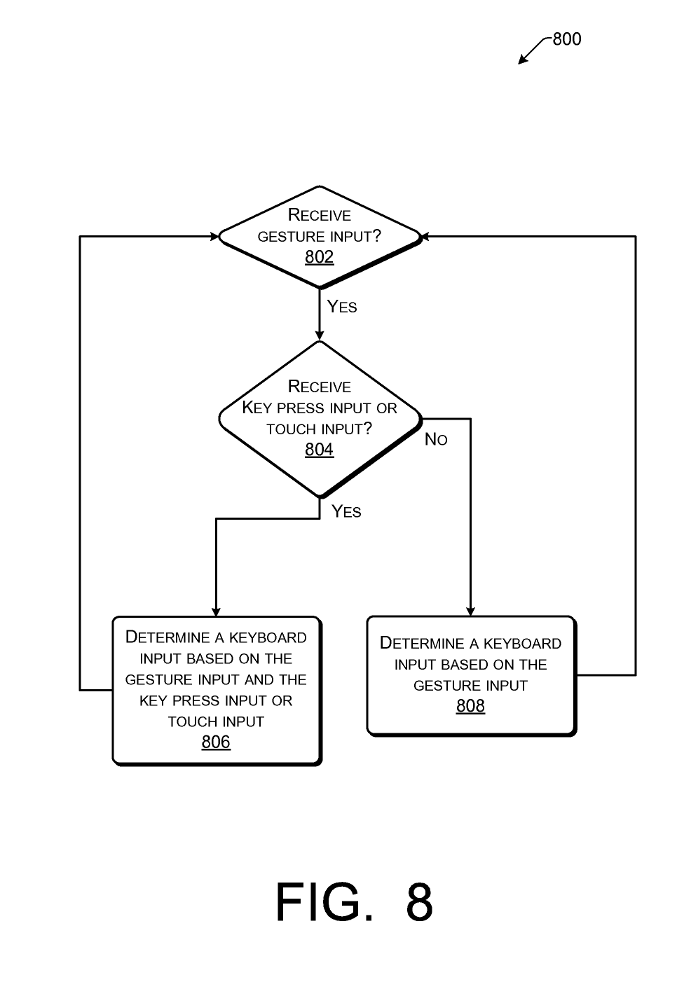

FIG. 8 is a flow diagram of another example method 800 of determining keyboard input for a physical keyboard according to some implementations. In the illustrative example of FIG. 8, the operations of the method 800 are performed by the keyboard signal module 218. In some implementations, one or more of the operations are performed by another component of the computing device 200, such as the operating system 216. In some examples, one or more of the operations are performed by the physical keyboard 104 (e.g., software, hardware, or a combination of hardware and software of the physical keyboard 104). Thus, logic in the physical keyboard 104 can perform one or more or each of the operations. For example, one or more of the modules and corresponding functionality of the computing device 200 can be incorporated into the physical keyboard 104.

At 802, if the keyboard signal module 218 determines that the physical keyboard 104 receives a gesture input from one or more gesture sensors, then the method proceeds to 804. At 804, if the keyboard signal module 218 determines that the physical keyboard 104 also receives a key press input or a touch input, then the method proceeds to 806. Otherwise, the method proceeds to 808. For example, the keyboard signal module can determine that a gesture input is received concurrent with or within a threshold amount of time of a key press input or touch input. At 806, the keyboard signal module 218 determines a keyboard input based on the gesture input and the key press input or the touch input. In some examples, the determination is made taking into account context. In other examples, the determination can be made based on one or more of the gesture input, the key press input, the touch input, and context. The method then returns to 802. At 808, the keyboard signal module 218 determines a keyboard input based on the gesture input. The method then returns to 802.

The example environments, systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and can be implemented in general purpose and special-purpose computing systems, or other devices having processing capability. Generally, any of the functions described with reference to the figures can be implemented using software, hardware (e.g., fixed logic circuitry) or a combination of these implementations. Thus, the processes, components and modules described herein can be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one example” “some examples,” “some implementations,” or similar phrases means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A system comprising:
a processor;
a display;
a physical keyboard comprising:
a single row of keys, each key configured to provide a key press input signal in response to being pressed; and
one or more gesture sensors, each respective gesture sensor configured to provide a gesture input signal in response to detecting a thumb gesture within a threshold distance of the respective gesture sensor; and
a keyboard signal module operable by the processor to:
receive the key press input signal;
determine a first keyboard input based at least in part on the key press input signal;
receive the gesture input signal; and
determine a second keyboard input based at least in part on the gesture input signal.

2. The system of claim 1, wherein the thumb gesture causes movement of a cursor presented on the display.

3. The system of claim 2, wherein the thumb gesture causes space bar functionality associated with the display.

4. The system of claim 1, wherein the one or more gesture sensors comprise:
one or more first sensors configured to detect gestures of a first thumb and one or more second sensors configured to detect gestures of a second thumb.

5. The system of claim 4, wherein the gestures of the first thumb and the gestures of the second thumb cause zooming in or zooming out for an area presented on the display.

6. The system of claim 4, wherein the gestures of the first thumb and the gestures of the second thumb cause rotation of an area presented on the display.

7. The system of claim 1, wherein a key of the single row of keys comprises:
an upper key touch sensor integrated with an upper portion of a top surface of the key;
a middle key touch sensor integrated with a middle portion of the top surface of the key; and
a lower key touch sensor integrated with a lower portion of the top surface of the key.

8. The system of claim 1, wherein a key of the single row of keys comprises:
a left side touch sensor integrated with a left side of the key; or
a right side touch sensor integrated with a right side of the key; or
a top side touch sensor integrated with a top side of the key; or
a bottom side touch sensor integrated with a bottom side of the key.

9. The system of claim 1, wherein the display presents a graphical representation of a one-to-many mapping associated with each key of the physical keyboard, wherein the graphical representation displays two or more keyboard inputs associated with each key.

10. A device comprising:
a single series of keys configured for use with a computing device, each key of the single series of keys configured to provide a key press input signal in response to being pressed; and
one or more touch sensors integrated with one or more of the keys, each touch sensor configured for providing a touch input signal in response to detecting a touch input.

11. The device of claim 10, further comprising a keyboard signal module to:
determine a keyboard input based on:
receiving the key press input signal in response to a key being pressed;
receiving a touch input signal in response to detecting, by a touch sensor of a plurality of touch sensors integrated with a key, the touch input; and
a one-to-many mapping of each of the keys to two or more keyboard inputs, wherein the keyboard input is selected based at least in part on a location of the touch sensor that detects the touch input; and
provide the keyboard input to an application.

12. The device of claim 10, wherein the single series of keys is curved.

13. The device of claim 10, further comprising one or more gesture sensors, each gesture sensor configured to provide a gesture input signal in response to detecting a gesture.

14. The device of claim 13, wherein detecting a gesture of one hand by one or more of the gesture sensors causes a different functionality associated with a display than detecting gestures of two different hands by two or more of the gesture sensors.

15. The device of claim 11, wherein the one-to-many mapping of each of the keys is configurable based on a user-defined mapping.

16. A method comprising:
receiving a key press input by one or more of a plurality of keys of a keyboard arranged in a series, each key of the plurality of keys configured to provide a key press input signal in response to receiving the key press input;
receiving a touch input by one or more touch sensors integrated with a surface of one or more of the plurality of keys;
determining one or more first keyboard inputs for a computing device based on the key press input and the touch input;
receiving a gesture input by one or more gesture sensors integrated with the keyboard, each gesture sensor configured to provide a gesture input signal in response to detecting a gesture; and
determining one or more second keyboard inputs for the computing device based on the gesture input.

17. The method of claim 16, wherein the determining one or more first keyboard inputs for a computing device is further based on a context associated with the key press input.

18. The method of claim 17, wherein the context associated with the key input comprises one or more of previously entered letters, numbers, symbols, words, sentences, or one or more previous determined keyboard inputs.

19. The method of claim 17, wherein the context associated with the key input comprises one or more of a time of day, user preferences, work activities of the user, leisure activities of the user, meetings attended by the user, and web sites visited by the user.

20. The method of claim 16, wherein the second keyboard inputs are associated with zooming in for an area presented on a display of the computing device, zooming out for the area presented on the display of the computing device, or rotating the area presented on the display of the computing device.
